(19) United States
(12) Patent Application Publication
(10) Pub. No.: US 2011/0080050 A1
(43) Pub. Date: Apr. 7, 2011

(54) Systems and Methods for Directional Reactive Power Ground Plane Transmission

(75) Inventors: Thomas George Thundat, Knoxville, TN (US); Charles W. Van Neste, Kingston, TN (US)

(73) Assignee: UT-BATTELLE, LLC, Oak Ridge, TN (US)

(21) Appl. No.: 12/572,349

(22) Filed: Oct. 2, 2009

(51) Int. Cl. H01F 38/00

(52) U.S. Cl. 307/104

(57) ABSTRACT

Systems and methods for transmitting electrical power through a ground plane are provided. A phased array of transmitters transmits moving, reactive power ground waves through a ground plane to a focus. A receiver, disposed proximate the focus, collects and converts the reactive power to real power for use in driving an electrical load. By adjusting the timing between the individual transmitters in the array, the focus may be moved to accommodate a mobile receiver. The reactive power ground waves may enter the receiver by conduction or induction.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### CROSS-REFERENCE TO RELATED APPLICATIONS

None.

### THE NAMES OF THE PARTIES TO A JOINT RESEARCH AGREEMENT

None.

### BACKGROUND OF THE INVENTION

1. Field of the Invention

The present disclosure generally relates to electrical power transmission systems and methods, and more specifically to reactive power ground wave distribution for use with near, remote, stationary, and mobile devices requiring electrical power to function.

2. Description of the Related Art

Electrical power is commonly supplied by a generation source to an electrical load in one of two ways: alternating current (AC) or direct current (DC). With AC current, the electrons flow multidirectionally, sometimes flowing in a first direction and then flowing in the opposite direction. With DC current, the electrons flow unidirectionally from the source to the load. Electrical power distribution for use in communities and businesses is typically supplied by AC current from a grid, while DC current is typically supplied by batteries, fuel cells or photovoltaic cells to power remote, mobile or portable devices such as sensors, vehicles, and radios for example.

### BRIEF SUMMARY OF THE INVENTION

Systems for transmitting electrical power to electronic devices requiring electrical power to function are provided. The systems include an array of two or more non-radiating transmitters for generating a series of moving, reactive power ground waves and transmitting the waves through a ground plane to a focus. Also included is a receiver proximate the focus for converting the ground waves to real power for use in driving an electrical load.

Methods of transmitting electrical power to electronic devices requiring electrical power to function are also provided. A series of moving, reactive power ground waves are generated and then transmitted with an array of two or more transmitters through a ground plane to a focus. The reactive power ground waves are collected by a receiver disposed proximate the focus and then converted to real power for use by one or more devices.

These and other objects, features and advantages will become apparent to those skilled in the art in view of the following detailed description and accompanying illustrations of multiple examples, where corresponding identifiers represent like features between the various figures.

### BRIEF DESCRIPTION OF THE SEVERAL VIEWS OF THE DRAWINGS

FIG. 1 is an orthographic, time-lapse view illustrating an electrical power transmission system in accordance with an example of the invention.

FIG. 2 is an orthographic view illustrating a first exemplary pattern of reactive power waves propagating from a transmitter array with a mobile receiver in a first position.

FIG. 3 is an orthographic view illustrating a second exemplary pattern of reactive power waves propagating from a transmitter array with a mobile receiver in a second position.

FIG. 4 is a flow chart illustrating the various method steps for transmitting directional reactive power through a ground plane.

### DETAILED DESCRIPTION OF THE INVENTION

When AC power is transmitted, both the voltage and current waves are sinusoidal shaped, alternating up and down many times a second. If the waves of voltage and current coincide, then multiplication of voltage and current occurs and real power is available. The unit of real power is the ‘Watt’ for Volts times Amps. When the voltage and current are peaking at different times, some amount of reactive power is being produced at the same time as the real power. The unit of reactive power is the ‘VAR’ for Volt-Ampere-Reactive. How much reactive power and in which direction it is flowing, depends on how different these peaking times are. When the voltage and current are generated with their peaks one quarter out of phase (e.g. 90 degrees out of phase) with respect to time, then the voltage peaks occur where the current shifts from positive to negative or vice-versa. In this example, only reactive power is being transmitted through the conductor.

An interesting phenomenon produced from reactive power generation is its ability to be transmitted by a single conductor without a return path. Electrical energy is transmitted via a single conductor, and through reflection of the load, that energy returns to the source. Thus a pseudo closed loop circuit is formed. Through resonant coupling, the reactive waves associated with the single conductor may be collected and converted back to real power. The real power can then be used to power a load.

Reactive power transfer resembles an oscillator, where loading the oscillator damps the system. The dampening is seen by the source, causing the source to work harder to keep the oscillations from dwindling. By replacing the single wire with a ground plane such as an earth-ground for example, it becomes possible to use the earth as the single conductor, thus allowing transmission of electrical power to any point on the globe without the need for separate conductors.

Another phenomenon is that of time reversal phased arraying. When multiple sources of disturbance are geometrically aligned, and the timing of their individual disturbances made into a pattern, it becomes possible to constructively and destructively add their disturbances together. The constructive disturbances will merge together to form a predefined focus, such as a point, area, beam, and ring, for example. At the focus, a maximum effect is observed with very little to no effect in areas surrounding the focus. Adjustment of the timing (e.g. phase and frequency) between two of more reactive power wave sources allows the movement of that focus. The movement of the focus allows the movement of a receiver, and thus the movement of a device requiring electric power to function.

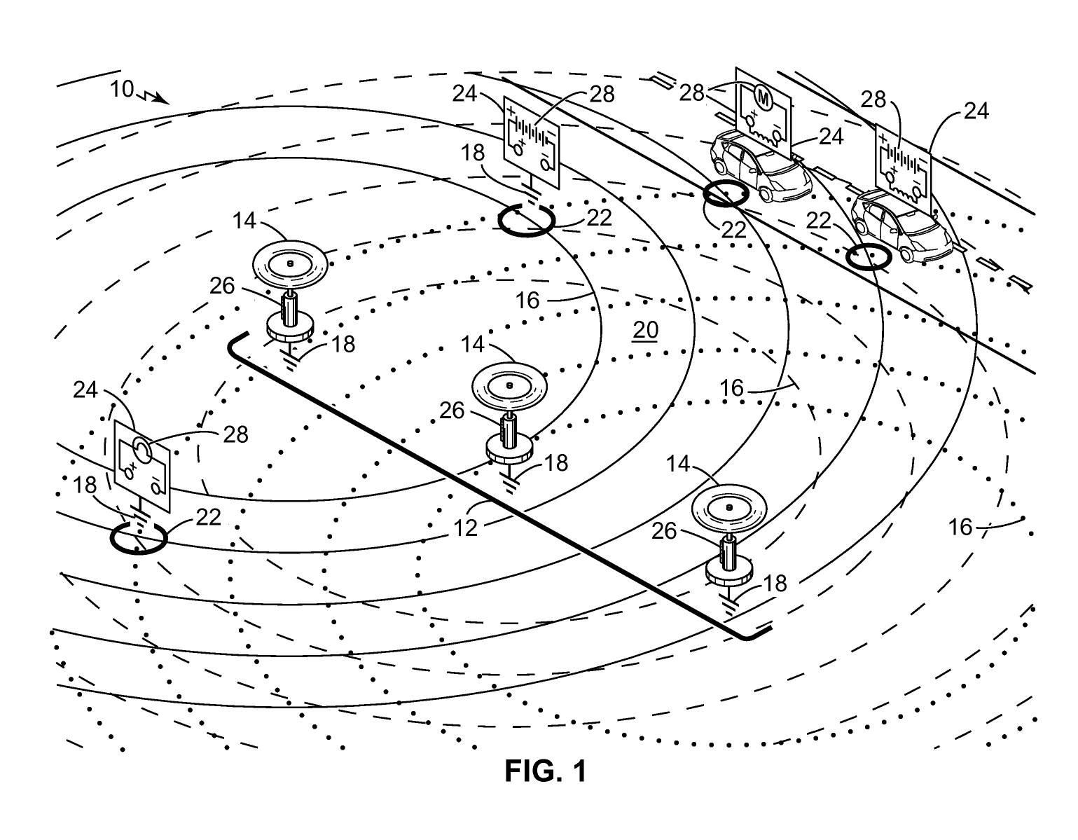

With reference first to FIG. 1, an exemplary electrical power transmission system 10 will now be described in greater detail. A phased array 12 of two or more non-radiating transmitters 14 produces moving reactive power waves 16 by modifying the alternating current output so the voltage and current are not in phase. With the voltage and current out-of-phase, some reactive power is produced. With the voltage and current configured to be one quarter out of phase (e.g. 90 degrees out of phase) then a maximum amount of reactive power is produced. The individual, reactive power waves 16 propagate outward and away from the transmitter 14, forming concentric rings when viewed over time.

The transmitter array 12 includes two or more individual, non-radiating transmitters 14 spaced apart from one another. A non-radiating transmitter is defined as an electrical device that produces maximized near field effect and very little, if any, far field effect. The near field effect is generally defined as covering a distance of two wavelengths or less. Such transmitters 14 may include near field radio antennas, Tesla coils, or solid state electronic devices for example. The transmitters 14 may be positioned in a geometric pattern such as a line, circle, clover, cross, U, V, X, Y, or some other pattern to improve the time reversal phase arraying of the waves. While only three transmitters 14 disposed in a single line pattern are illustrated in FIG. 1, it is to be understood that additional transmitters 14 are contemplated and that additional transmitters 14 will generally transmit additional reactive power. A conductive ground connection 18, such as a copper or steel post, plate, spring or strap for example, conveys the reactive power from each transmitter 14 to a ground plane 20. Additionally, an individual transmitter 14 or the entire array 12 of transmitters may be fixed or may be mobile.

The operation timing of the transmitter 14, defined by the phase and frequency, causes the reactive power ground waves 16 to constructively and destructively combine with one another in a phased array. It is this time reversal phased arraying that produces one or more focuses 22 that are located at predefined locations in the ground plane 20. Generally, all transmitters 14 in the array 12 will operate at the same frequency or harmonics of that frequency, with only the phase of each transmitter 14 being different from the next. Essentially, the operating frequency is any integer multiple of the fundamental frequency. The geometric location of each transmitter 14 in the phased array 12 and the operational timing contribute to the merging of waves 16 at the predefined locations of the foci 22.

As discussed briefly earlier, a conductive ground connection 18 transfers the reactive power ground waves 16 from the transmitters 14 to the ground plane 20. The ground plane 20 can be any conductive or semi-conductive body that may include a wire, plate, liquid, solid, celestial body, and ionized gas for example. In some examples, the ground plane 20 is the earth. With the earth functioning as the ground plane 20, traditional infrastructure such as transmission lines and utility poles are not required for transferring power.

One or more receivers 24, spaced apart from the transmitter array 12, collect the reactive power ground waves 16 proximate the focus 22. The receivers 24 convert the reactive power to real power through resonant coupling, also known as wireless energy transfer. Each ground wave receiver 24 may include a near-field radio antenna, Tesla coil, or solid state electronic device, for example. Generally, the receiver 24 is tuned to have the same resonant frequency as the moving ground waves, or harmonics thereof. Essentially, this is any integer multiple of the fundamental frequency. If the receiver 24 is located proximate a predefined focus 22 of the reactive power ground waves 16, electrical energy will be transmitted to the receiver 24. If the receiver 24 is outside of the proximity of the focus 22, the energy received will be near zero. Multiple receivers 24 may be powered if the time constant of each receiver 24 is slow enough to allow the movement of the focus 22 between each receiver 24, or if the focus 22 is large enough to accommodate multiple receivers 24 in a given focus area.

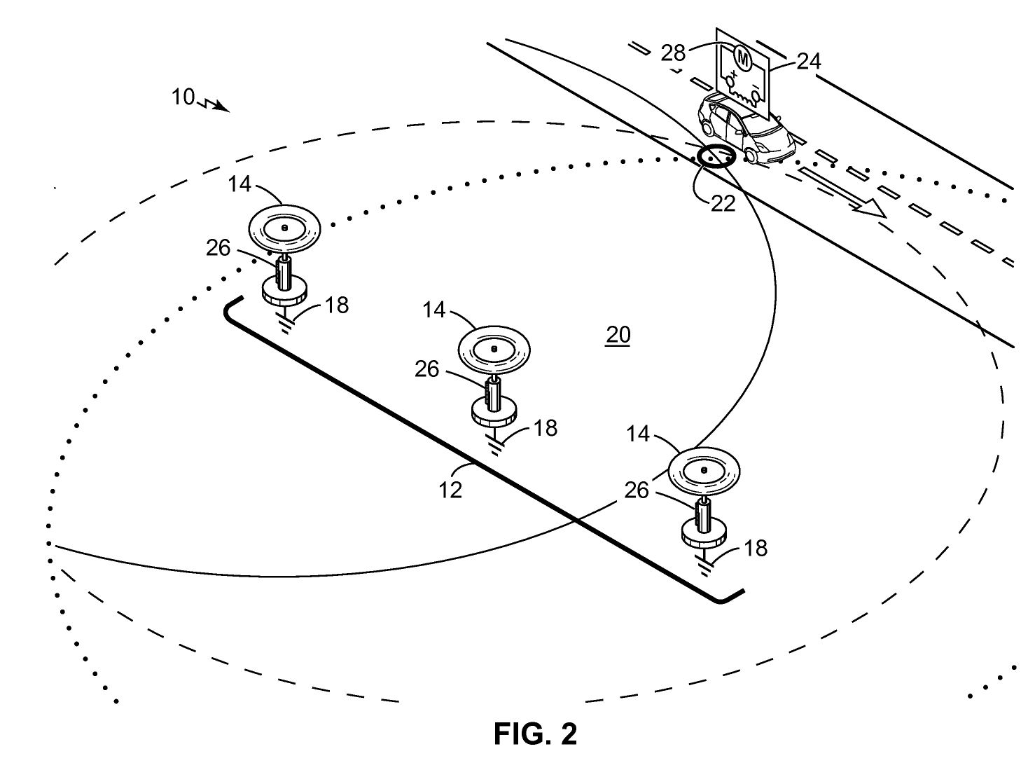

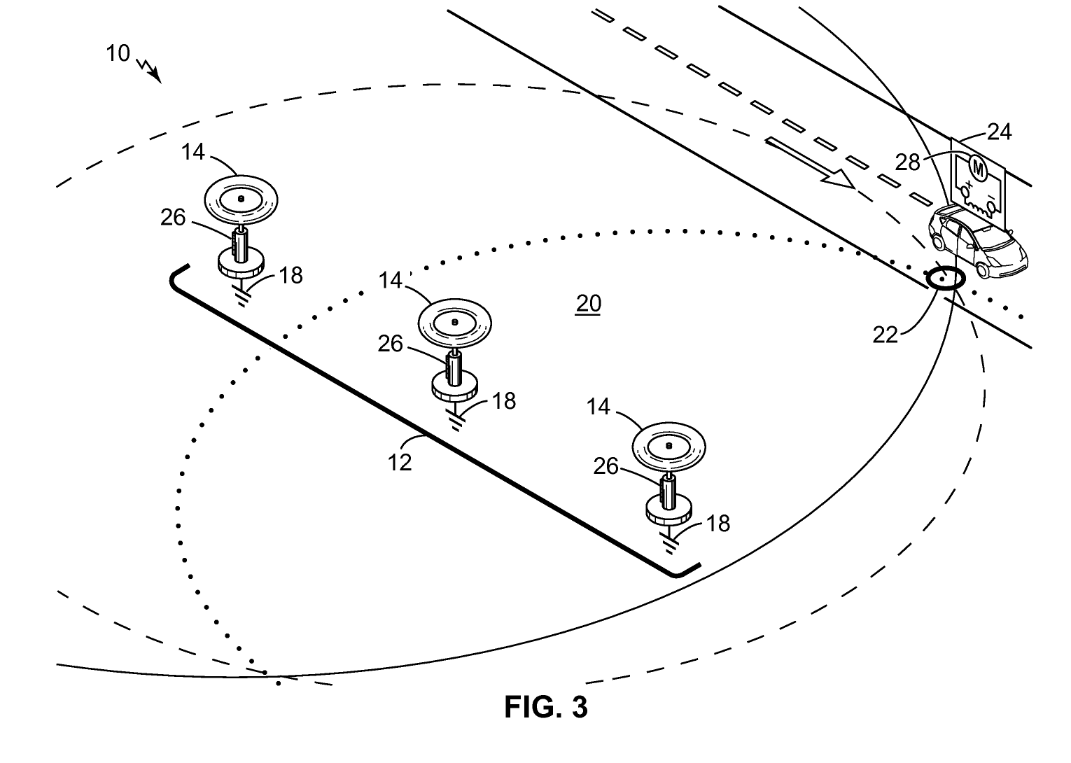

If the timing (e.g. phase and frequency) between the individual transmitters 14 is altered, the physical location, size and shape of a focus 22 can be altered. This is best illustrated in FIGS. 2 and 3. Please note that FIG. 2 and FIG. 3 are illustrative of two different time periods, where FIG. 2 illustrates a time that is earlier than FIG. 3. Here, the focus 22 moves along the ground plane 20 in a predefined path to power one or more mobile receivers 24. In this particular example, a zero emissions vehicle moves along a roadway from a first location in FIG. 2 to a second location in FIG. 3. By modifying the frequency of the waves 16, the focus moves laterally in and out, while modifying the phase of the waves 16 sweeps the focus 22 back and forth. By modifying the frequency and phase simultaneously as discussed earlier, the path, size and shape of the focus 22 may be modified, as discussed earlier.

A manual, semiautomatic or fully automatic controller 26 modifies the timing of the transmitters 14 to direct the path, size and shape of the focus 22 on the ground plane 20. The controller 26 may be directed by a predefined sequence of commands programmed into a computer for example. In another example, the controller 26 is commanded manually by an operator with a joystick. In yet another example, the controller 26 is directed by a receiver 24. In this particular example, the receiver 24 may move in any direction while communicating the instantaneous directional information to the controller 26 by radiating radio waves for example. The controller 26 then modulates the timing of the transmitters 14 to ensure a focus 22 is proximate the receiver 24 at all times as it moves.

The reactive power ground waves may be directly collected by the receiver 24, from the ground plane 20, through a conductive ground connection 18 such as a copper or steel post, plate, spring or strap for example. In one example, the ground connection 18 transfers the reactive power from the ground plane 20 to a single receiver 24 at the focus 22. In another example, a receiver 24 does not directly contact the ground plane 20 and the reactive power ground waves are inductively transmitted to the receiver 24. A magnetic or electric field at the focus 22 is sufficient to induce charge movement in the receiver 24.

Any load 28 that requires electrical power to operate may be connected to a reactive power ground wave receiver 24. A load 28 can be a light bulb, radio, battery charger, and motor, for example. In one example, the load 28 is a lamp in a perimeter security system. In another example, the load 28 is a battery charger for use by soldiers in the field. In this example, the need to carry spare batteries for weaponry and communication devices into combat is eliminated. In another example, the load 28 is a lamp array used to illuminate a roadway as a vehicle passes. In another example, the load is a motor for powering a zero or low emissions vehicle. In this example, the focus 22 is swept along a predefined path or roadway, powering the vehicle's motor through induction as it moves from position A to position B. In a similar example, a vehicle's battery is recharged automatically as the vehicle moves, or is recharged at a charging station without the need for a cable to transfer the power. As can be appreciated by those skilled in the art, the examples described above are for illustrative purposes only, and are in no way to be considered a comprehensive list of possible uses and applications.

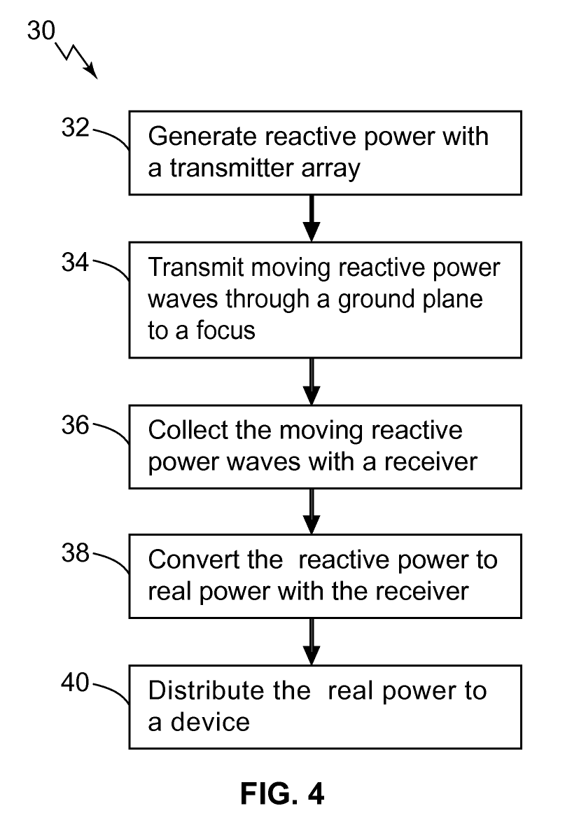

Referring lastly to FIG. 4, various method steps for transmitting reactive power 30 are illustrated. In the first step represented by block 32, reactive power is generated by an array of two or more non-radiating transmitters as described in detail above. The reactive power is transmitted in a series of moving, reactive power ground waves through a ground plane to a focus in a second step represented by block 34. Once the moving, reactive power ground waves merge at the predefined focus, a receiver disposed proximate the focus collects the waves in the third step represented by block 36. After the receiver has collected the series of moving, reactive power ground waves, the receiver converts the reactive power to real power in the fourth step represented by block 38. Finally, in a fifth step represented by block 40, the real power is distributed to a device requiring electrical power to function.

Other alternatives, modifications, equivalents, and variations will become apparent to those skilled in the art having reviewed the figures and read the foregoing description. Accordingly, the invention is intended to embrace those alternatives, modifications, equivalents, and variations as fall within the broad scope of the appended claims. The technology disclosed and claimed is available for license by the assignee of record.

What is claimed is:

1) An electrical power transmission system for transmitting power through a ground plane comprising:
a phased array of two or more non-radiating transmitters capable of generating a series of moving, reactive power ground waves and transmitting the waves through the ground plane to a focus; and
a receiver, spaced apart from the array of transmitters and proximate the focus, for converting the series of moving, reactive power ground waves to real power for use in driving an electrical load.

2) The electrical power transmission system as recited in claim 1 wherein the series of moving, reactive power ground waves are electromagnetic waves with each wave having a voltage and amperage that are out-of-phase with one another.

3) The electrical power transmission system as recited in claim 1 wherein the phase and frequency of each transmitter in the array of transmitters is chosen so the series of reactive power ground waves merge at the focus.

4) The electrical power transmission system as recited in claim 1 wherein each of the individual transmitters in said array of transmitters operates at the same frequency or harmonic of that frequency and at a different phase than all the other transmitters in said array of transmitters.

5) The electrical power transmission system as recited in claim 1 wherein each of the individual transmitters in said array of transmitters is selected from the group consisting of a near field radio antenna, a Tesla coil, and a solid state electronic device.

6) The electrical power transmission system as recited in claim 1 wherein the phase and frequency between each of the individual transmitters in said array of transmitters is directed by a controller to cause the focus to move.

7) The electrical power transmission system as recited in claim 1 wherein said receiver contacts the ground plane through a conductive ground connection.

8) The electrical power transmission system as recited in claim 1 wherein said receiver does not contact the ground plane and the reactive power ground waves are inductively transmitted to said receiver from the ground plane.

9) The electrical power transmission system as recited in claim 6 wherein said receiver is movable and the focus is movable in order to maintain close proximity with said receiver.

10) The electrical power transmission system as recited in claim 1 wherein said receiver is a plurality of receivers.

11) The electrical power transmission system as recited in claim 1 wherein the electrical load is a device requiring electrical power to function.

12) A method of transmitting electrical power through a ground plane comprising the steps of:
a) generating reactive power with a phased array of two or more non-radiating transmitters;
b) transmitting a series of moving, reactive power ground waves with the transmitters through the ground plane to a focus;
c) collecting the series of reactive power ground waves with a receiver disposed proximate the focus; and
d) converting the series of reactive power ground waves to real power with the receiver.

13) The method as recited in claim 12 further comprising the step of e) distributing the real power to a device requiring electrical power to function.

14) The method as recited in claim 12 wherein the series of reactive power ground waves are electromagnetic waves with each wave having voltage and amperage that are out-of-phase with one another.

15) The method as recited in claim 12 wherein the phase and frequency of each transmitter in the array of transmitters are chosen so the series of reactive power ground waves merge at the focus.

16) The method as recited in claim 12 wherein the transmitting step b) further includes directing the phase and frequency between each of the individual transmitters in said array of transmitters by a controller to cause the focus to move.

17) The method as recited in claim 12 wherein the collecting step is performed by induction.

18) The method as recited in claim 12 wherein the collecting and converting steps are performed by a moveable receiver.

19) The method as recited in claim 13 wherein the device requiring electrical power to function is a motor.

20) The method as recited in claim 13 wherein the device requiring electrical power to function is a battery charger.
